(19) United States
(12) Patent Application Publication
(10) Pub. No.: US 2026/0277368 A1
(43) Pub. Date: Sep. 17, 2026

(54) ELECTROSTATIC INPUT DEVICE AND ELECTROSTATIC DETECTION DEVICE

(71) Applicant: ALPS ALPINE CO., LTD., Tokyo (JP)

(72) Inventor: Takashi FUJIKI, Miyagi (JP)

(21) Appl. No.: 19/657,966

(22) Filed: Apr. 24, 2026

Related U.S. Application Data
(63) Continuation of application No. PCT/JP2024/041176, filed on Nov. 20, 2024.

(30) Foreign Application Priority Data
Dec. 27, 2023 (JP) 2023-220862

(51) Int. Cl. G06F 3/044; B62D 1/04; G06F 3/041

(52) U.S. Cl. CPC G06F 3/044; B62D 1/046; G06F 3/0416

(57) ABSTRACT

An electrostatic input device includes: a sensor electrode provided on a back side of an operation surface of a cover; a measurement circuit connected to the sensor electrode; a determination unit configured to perform, based on a capacitance of the sensor electrode obtained from an output of the measurement circuit, a failure determination for determining a failure of the sensor electrode and an operation determination for determining contact or proximity of an object to the operation surface; and a sensitivity setting unit configured to set a first output sensitivity of the measurement circuit in the failure determination performed by the determination unit to be lower than a second output sensitivity of the measurement circuit in the operation determination performed by the determination unit.

### CROSS-REFERENCE TO RELATED APPLICATIONS

This application is a continuation application of International Application No. PCT/JP2024/041176, filed on Nov. 20, 2024, and designated the U.S., which is based upon and claims priority to Japanese Patent Application No. 2023-220862, filed on Dec. 27, 2023, the entire contents of which are incorporated herein by reference.

### BACKGROUND OF THE INVENTION

### 1. Field of the Invention

The present disclosure relates to an electrostatic input device and an electrostatic detection device.

### 2. Description of the Related Art

A touch panel system is known in the related art, which includes a projected capacitive touch panel and a touch panel controller configured to receive a signal from the touch panel and detect a touch operation by a user based on the received signal, in which the touch panel controller accumulates the received signal from the touch panel a plurality of times and detects the touch operation by comparing an accumulated signal value with a touch operation detection threshold, and includes a touch operation sensitivity changing unit configured to change sensitivity of the touch operation detected in the touch panel, and the touch operation sensitivity changing unit changes the sensitivity of the touch operation by increasing or decreasing the number of times the received signal is accumulated (see, for example, Japanese Patent Application Laid-Open Publication No. 2012-248035).

### SUMMARY OF THE INVENTION

An electrostatic input device according to an embodiment of the present disclosure includes: a sensor electrode provided on a back side of an operation surface of a cover; a measurement circuit connected to the sensor electrode; a determination unit configured to perform, based on a capacitance of the sensor electrode obtained from an output of the measurement circuit, a failure determination for determining a failure of the sensor electrode and an operation determination for determining contact or proximity of an object to the operation surface; and a sensitivity setting unit configured to set a first output sensitivity of the measurement circuit in the failure determination performed by the determination unit to be lower than a second output sensitivity of the measurement circuit in the operation determination performed by the determination unit.

### BRIEF DESCRIPTION OF THE DRAWINGS

FIG. 1 is a diagram illustrating an example of a configuration of a steering wheel provided with an operation unit of an electrostatic input device according to an embodiment;

FIG. 2 is a diagram illustrating an electrostatic input device 100 according to an embodiment;

FIG. 3A is a graph for explaining operation determination and failure determination in a comparative electrostatic input device;

FIG. 3B is a graph for explaining operation determination and failure determination in the comparative electrostatic input device;

FIG. 4A is a graph for explaining an example of operation determination and failure determination in the electrostatic input device according to an embodiment;

FIG. 4B is a graph for explaining an example of operation determination and failure determination in the electrostatic input device according to an embodiment;

FIG. 5A is a diagram illustrating an example of an operation of the electrostatic input device according to an embodiment in a scan period;

FIG. 5B is a diagram illustrating an example of details of operation determination for a sensor electrode of the electrostatic input device according to an embodiment; and

FIG. 6 is a flowchart illustrating an example of processes executed by an information processing unit of the electrostatic input device according to an embodiment.

### DESCRIPTION OF THE EMBODIMENTS

In an electrostatic input device using capacitance, such as a touch panel system, when determining a failure of a sensor electrode, it may not be possible to distinguish whether an increase in capacitance is caused by a failure such as a short circuit of the sensor electrode or by contact of a portion larger than a fingertip, such as a palm or an arm.

However, touch panel systems in the related art do not change touch operation sensitivity. Therefore, such distinction is not possible.

Therefore, the present disclosure provides an electrostatic input device and an electrostatic detection device capable of improving determination accuracy of failure determination by lowering output sensitivity of capacitance when performing failure determination for a sensor electrode.

Hereinafter, embodiments in which an electrostatic input device and an electrostatic detection device according to the present disclosure are applied will be described.

### Embodiments

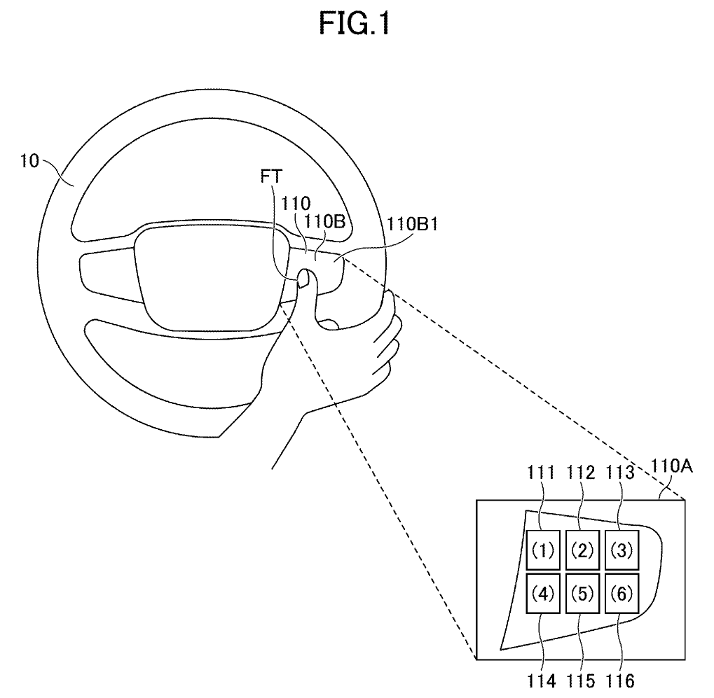

FIG. 1 is a diagram illustrating an example of a configuration of a steering wheel 10 provided with an operation unit 110 of an electrostatic input device 100 according to an embodiment. The steering wheel 10 is arranged in a driver’s seat of a vehicle, and the operation unit 110 is provided on a spoke. FIG. 1 illustrates, as an example, a state in which the operation unit 110 is operated by a fingertip FT (e.g., a thumb illustrated in FIG. 1) of a user’s right hand. The fingertip FT is an example of an object. In the following, a configuration in which an operation is performed using the fingertip FT will be described as an example. However, the operation may be performed using something other than the fingertip FT.

The vehicle is an automobile capable of traveling on a road using a power source such as an engine and/or a motor. The vehicle may be equipped with various levels of automated driving functions defined, for example, by the Society of Automotive Engineers (SAE) International.

As illustrated in the enlarged view, the operation unit 110 includes, for example, six sensor electrodes 111 to 116. In the enlarged view illustrating the sensor electrodes 111 to 116, a cover covering the sensor electrodes 111 to 116 is omitted. The sensor electrodes 111 to 116 are an example of a plurality of sensor electrodes. Here, regions in which the sensor electrodes 111 to 116 are arranged are denoted by (1) to (6), respectively. Although a configuration in which the operation unit 110 includes the six sensor electrodes 111 to 116 is described in this example, the operation unit 110 includes at least one sensor electrode.

The operation unit 110 includes a voltage output unit configured to apply AC power having a predetermined frequency to the sensor electrodes 111 to 116 when a determination unit 123 performs operation determination and failure determination. However, the voltage output unit is omitted here. Driving control of the voltage output unit is performed by a main control unit 121 of a control device 120 described later.

The sensor electrodes 111 to 116 are housed in a housing 110A, covered by a cover 110B, and provided on a spoke of the steering wheel 10. A surface of the cover 110B is an operation surface 110B1 on which the user can perform an operation using the fingertip FT or the like. The sensor electrodes 111 to 116 are positioned on a back side of the operation surface 110B1.

Here, a surface of the resin cover 110B covering the sensor electrodes 111 to 116 serves as the operation surface 110B1. However, when a member covering the sensor electrodes 111 to 116 is a protective film, a protective coating film, or the like, a surface of the protective film, the protective coating film, or the like serves as the operation surface 110B1. The fact that the sensor electrodes 111 to 116 are positioned on the back side of the operation surface 110B1 means that the sensor electrodes 111 to 116 are not exposed but instead are covered by the cover 110B, the protective film, the coating film, or the like.

When the user operates any one of the regions (1) to (6) of the operation surface 110B1 using the fingertip FT or the like, capacitance is detected through a sensor electrode (any one of the sensor electrodes 111 to 116) corresponding to the operated region.

The sensor electrodes 111 to 116 are arranged substantially in a matrix of two rows in a vertical direction and three columns in a horizontal direction. The sensor electrodes 111 to 116 are electrodes made of, for example, a metal foil, a metal plate, a conductive film, or the like, and are connected to a control device (not illustrated) via wires, cables, or the like. Capacitance between the sensor electrodes 111 to 116 and the fingertip FT (see FIG. 1) varies depending on a degree of proximity (distance) of the fingertip FT to the sensor electrodes 111 to 116. Since the sensor electrodes 111 to 116 are covered by the cover 110B in use, the capacitance between the sensor electrodes 111 to 116 and the fingertip FT (see FIG. 1) varies depending on the distance between the fingertip FT, which is in contact with or in proximity to the operation surface 110B1, and the operation surface 110B1.

The sensor electrodes 111 to 116 are used, for example, to operate various electrical devices of a vehicle. By touching, with a fingertip or the like, a portion of a surface of the cover 110B corresponding to any one of the sensor electrodes 111 to 116, a desired electrical device of the vehicle can be operated. Functions of the electrical devices operable via the sensor electrodes 111 to 116 include, for example, selection of audio tracks, adjustment of volume, initiation or termination of a handsfree call, and setting of cruise control.

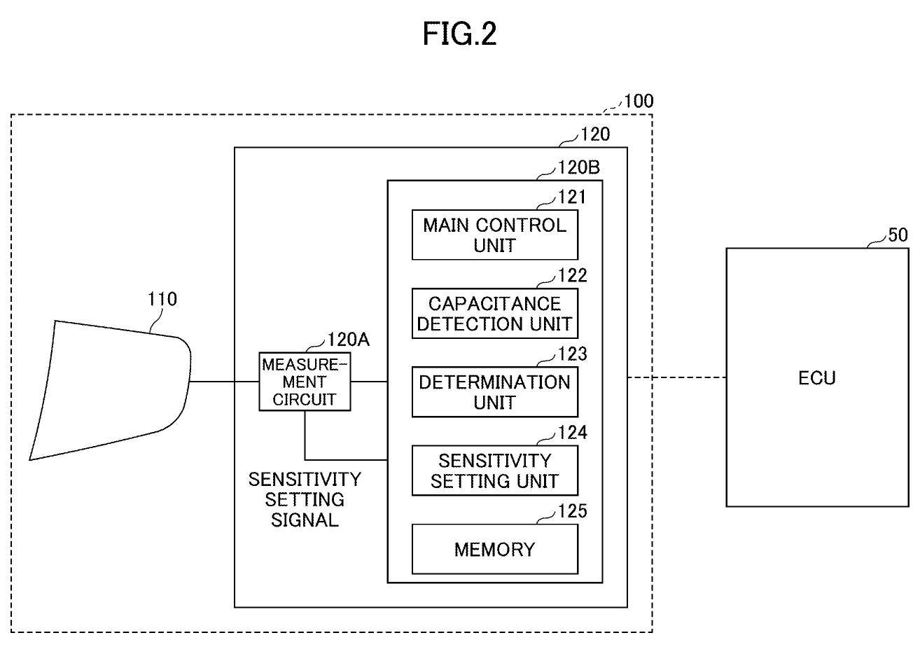

FIG. 2 is a diagram illustrating the electrostatic input device 100 according to the embodiment. The electrostatic input device 100 includes the operation unit 110 and the control device 120. The operation unit 110 includes the sensor electrodes 111 to 116 (see FIG. 1), which are omitted in FIG. 2. For example, the electrostatic input device 100 detects a touch operation using self-capacitance. The touch operation refers to an operation in which the fingertip FT or the like contacts the regions (1) to (6) of the operation surface 110B1 of the cover 110B that covers the sensor electrodes 111 to 116.

Here, an example configuration is described in which the electrostatic input device 100 detects a touch operation on the regions (1) to (6) of the operation surface 110B1. However, the electrostatic input device 100 may detect a proximity operation in which an object approaches the regions (1) to (6) without contacting the operation surface 110B1.

### Control Device 120

The control device 120 includes a measurement circuit 120A and an information processing unit 120B. The control device 120 is, for example, an integrated circuit (IC) chip. Here, an example configuration is described in which the control device 120 is configured as an IC chip and includes the measurement circuit 120A and the information processing unit 120B. However, the measurement circuit 120A may be provided outside the control device 120 configured as an IC chip.

### Measurement Circuit 120A

The measurement circuit 120A is an analog front end and is connected to the sensor electrodes 111 to 116. The measurement circuit 120A includes an amplifier and an analog-to-digital (A/D) converter. The amplifier amplifies a current of the sensor electrodes 111 to 116, thereby increasing an apparent capacitance of the sensor electrodes 111 to 116. The A/D converter converts the increased capacitance into a digital signal and outputs the digital signal.

An amplification factor (gain) of the amplifier included in the measurement circuit 120A is configured to be adjusted by a sensitivity setting unit 124 of the information processing unit 120B. By changing the amplification factor (gain) of the amplifier, an output sensitivity of the measurement circuit 120A is changed. Changing the output sensitivity of the measurement circuit 120A is equivalent to changing a numerical level of capacitance (count value) detected by a capacitance detection unit 122 based on the output of the measurement circuit 120A, that is, changing an output sensitivity of the capacitance.

The operation unit 110 and the measurement circuit 120A are connected via wires, cables, or the like, and the measurement circuit 120A and the information processing unit 120B are connected via wires, cables, or the like. The control device 120 is, for example, provided on the steering wheel 10 and is integrally configured with the operation unit 110. Here, an example configuration is described in which the control device 120 is provided on the operation unit 110 and is integrally configured with the operation unit 110. However, the control device 120 may be configured separately from the operation unit 110 and may be provided outside the steering wheel 10 within a vehicle cabin.

### Information Processing Unit 120B

The information processing unit 120B of the control device 120 is connected to an electronic control unit (ECU) 50 configured to control electrical devices via an in-vehicle network, such as a controller area network (CAN) or a local interconnect network (LIN) installed in a vehicle. The ECU 50 is an electronic control device configured to control audio, a handsfree phone, cruise control, and other electrical components of the vehicle. Although one ECU 50 is illustrated in FIG. 2, a plurality of ECUs 50 may be connected to the control device 120.

The information processing unit 120B is implemented by a computer including a central processing unit (CPU), a random access memory (RAM), a read-only memory (ROM), an input/output interface, an internal bus, and the like.

The information processing unit 120B includes the main control unit 121, the capacitance detection unit 122, the determination unit 123, the sensitivity setting unit 124, and a memory 125. The main control unit 121, the capacitance detection unit 122, the determination unit 123, and the sensitivity setting unit 124 represent functions of a program executed by the control device 120 as functional blocks. The memory 125 functionally represents a memory of the control device 120.

### Main Control Unit 121

The main control unit 121 is configured to centrally control processes executed by the information processing unit 120B, and executes processes other than those performed by the capacitance detection unit 122, the determination unit 123, and the sensitivity setting unit 124. For example, when the determination unit 123 performs operation determination, the main control unit 121 controls the voltage output unit of the operation unit 110 to apply AC power having N (N is an integer of 2 or more) types of frequencies to the sensor electrodes 111 to 116. When the determination unit 123 performs failure determination, the main control unit 121 controls application of AC power having M (M is a natural number less than N) types of frequencies to the sensor electrodes 111 to 116. Such control is drive control of the voltage output unit of the operation unit 110 by the main control unit 121.

### Capacitance Detection Unit 122

The capacitance detection unit 122 detects the capacitance of the sensor electrodes 111 to 116 (see FIG. 1) by integrating the output of the measurement circuit 120A, and transmits, to the determination unit 123, data representing a count value of the capacitance of each of the sensor electrodes 111 to 116. By integrating the output of the measurement circuit 120A, the capacitance detection unit 122 can detect the capacitance of the sensor electrodes 111 to 116 while reducing the influence of noise and the like included in the output of the measurement circuit 120A. The capacitance of the sensor electrodes 111 to 116 detected by the capacitance detection unit 122 is represented by count values. The count values are digital values. The capacitance detection unit 122 detects the capacitance (count value) for each of the sensor electrodes 111 to 116.

When the determination unit 123 performs a failure determination, the capacitance detection unit 122 detects the capacitance of the sensor electrodes 111 to 116 by integrating the output of the measurement circuit 120A a first number of times. When the determination unit 123 performs an operation determination, the capacitance detection unit 122 detects the capacitance of the sensor electrodes 111 to 116 by integrating the output of the measurement circuit 120A a second number of times. The first number of integrations is smaller than the second number of integrations. Details will be described later.

When the determination unit 123 performs a failure determination, the capacitance detection unit 122 outputs, to the determination unit 123, the detected capacitance of each of the sensor electrodes 111 to 116.

When the determination unit 123 performs an operation determination, the capacitance detection unit 122 outputs, to the determination unit 123, a difference value ΔAD obtained by subtracting the capacitance detected in a state where no operation is performed on the sensor electrodes 111 to 116 from the capacitance detected in a state where an operation is performed on the sensor electrodes 111 to 116.

### Determination Unit 123

The determination unit 123 performs a failure determination for determining a failure of the sensor electrodes 111 to 116 based on count values of the capacitance of the respective sensor electrodes 111 to 116 transmitted from the capacitance detection unit 122, and performs an operation determination for determining contact of the fingertip FT with any of the regions (1) to (6) of the operation surface 110B1 based on a difference value ΔAD of the capacitance. The determination unit 123 sequentially selects the plurality of sensor electrodes 111 to 116 one by one, and performs the failure determination and the operation determination for each of the sensor electrodes 111 to 116. Details will be described later.

The failure determination is, for example, a determination process for determining whether a short circuit (short-circuit failure) has occurred in the sensor electrodes 111 to 116. The determination unit 123 performs the failure determination by comparing the capacitance of the sensor electrodes 111 to 116 detected by the capacitance detection unit 122 with a failure determination threshold.

The operation determination is a determination process for determining that a touch operation has been performed on any one of the sensor electrodes 111 to 116. The determination unit 123 performs the operation determination by comparing the difference value ΔAD of the capacitance of the sensor electrodes 111 to 116 output from the capacitance detection unit 122 with an operation determination threshold, thereby determining proximity of the fingertip FT to any of regions (1) to (6) of the operation surface 110B1.

When the electrostatic input device 100 detects a proximity operation instead of a touch operation, the operation determination performed by the determination unit 123 is a process for determining proximity of the fingertip FT to any of the regions (1) to (6) of the operation surface 110B1. When the electrostatic input device 100 is capable of detecting a proximity operation in addition to a touch operation, the operation determination performed by the determination unit 123 is a process for determining contact or proximity of the fingertip FT to any of the regions (1) to (6) of the operation surface 110B1.

The determination result of the determination unit 123 represents one of the sensor electrodes 111 to 116 on which a touch operation has been performed. The determination result of the determination unit 123 is a detection result of the electrostatic input device 100, indicating which of the sensor electrodes 111 to 116 has been subjected to the touch operation. The determination process executed by the determination unit 123 will be described later.

### Sensitivity Setting Unit 124

The sensitivity setting unit 124 sets an output sensitivity of the measurement circuit 120A by outputting a sensitivity setting signal to the measurement circuit 120A. More specifically, the sensitivity setting unit 124 sets a first output sensitivity of the measurement circuit 120A in failure determination performed by the determination unit 123 to be lower than a second output sensitivity of the measurement circuit 120A in operation determination performed by the determination unit 123.

The first output sensitivity is an amplification factor defined such that, even when coupling between the sensor electrodes 111 to 116 and an object becomes maximum due to contact or proximity of the object to the operation surface 110B1 in failure determination performed by the determination unit 123, the capacitance of the sensor electrodes 111 to 116 detected by the capacitance detection unit 122 is lower than a failure determination threshold. Details will be described later.

### Memory 125

The memory 125 stores programs, data, and the like necessary for the information processing unit 120B to perform the determination process. The memory 125 stores data representing count values of capacitances of the sensor electrodes 111 to 116, and data generated by the determination unit 123 during the determination processing.

The memory 125 also stores data representing the M types and N of frequencies of AC power output by the voltage output unit of the operation unit 110, data representing numbers of integrations (a first number of integrations and a second number of integrations) for detecting capacitances of the sensor electrodes 111 to 116, and data representing output sensitivities (the first output sensitivity and the second output sensitivity) of the measurement circuit 120A.

### Electrostatic Detection Device of Embodiment

In the present embodiment, the electrostatic input device 100 will be described. However, by making the following modifications to the device described as the electrostatic input device 100, the device can be used as an electrostatic detection device.

In the electrostatic detection device of the embodiment, the sensor electrodes 111 to 116 need not be provided on the back side of the operation surface 110B1. The electrostatic detection device of the embodiment is a device configured to perform proximity determination for determining proximity of an object to the sensor electrodes 111 to 116, instead of the operation determination performed by the electrostatic input device 100, and need not perform the operation determination performed by the electrostatic input device 100. The electrostatic detection device of the embodiment includes at least one sensor electrode. The electrostatic detection device of the embodiment may be incorporated into, for example, any device that requires determination for proximity of an object. For example, the electrostatic device of the embodiment may be incorporated into a tablet input device placed in a store or facility and used by an unspecified number of users, or into an automatic teller machine (ATM).

### Operation Determination and Failure Determination in Comparative Electrostatic Input Device

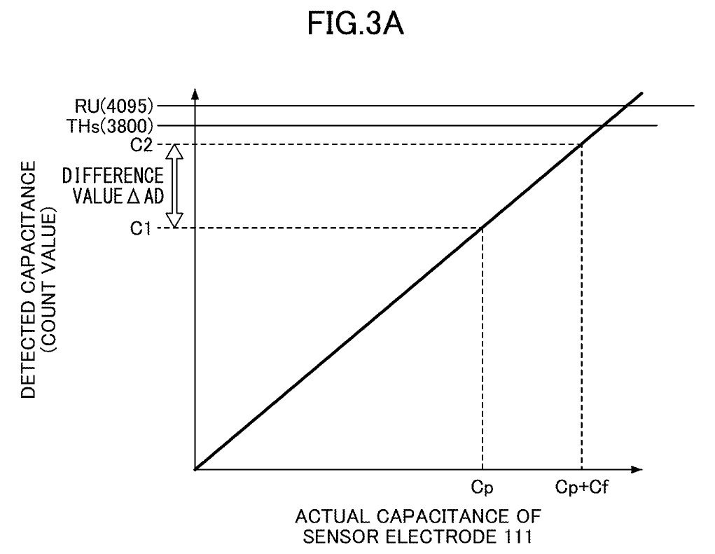

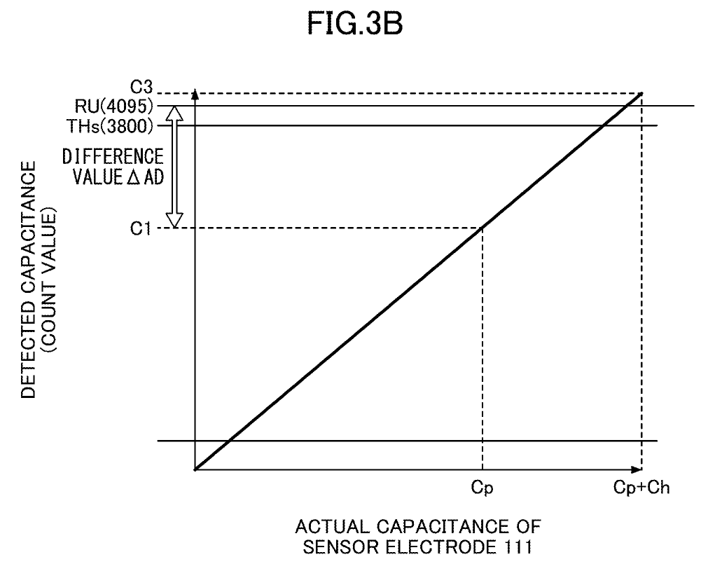

Here, operation determination and failure determination in a comparative electrostatic input device will be described with reference to FIGS. 3A and 3B.

The comparative electrostatic input device does not include the sensitivity setting unit 124, and sets the output sensitivity of the measurement circuit 120A to the same value for both failure determination performed by the determination unit 123 and operation determination performed by the determination unit 123.

The comparative electrostatic input device also sets the number of integrations (a predetermined number) for the capacitance detection unit 122 to detect capacitances of the sensor electrodes 111 to 116 to the same number for both failure determination and operation determination performed by the determination unit 123.

The comparative electrostatic input device also sets the number of types of frequencies of AC power to be applied to the sensor electrodes 111 to 116 by the voltage output unit of the operation unit 110 to the same number for both failure determination and operation determination performed by the determination unit 123.

First, with reference to FIG. 3A, capacitances detected by the capacitance detection unit 122 during a touch operation with the fingertip FT on the operation surface 110B1 will be described in a case where none of the sensor electrodes 111 to 116 of the comparative electrostatic input device has a short-circuit failure. Here, as an example, a touch operation is performed on the region (1) corresponding to the sensor electrode 111.

In FIG. 3A, the horizontal axis represents the actual capacitance of the sensor electrode 111, and the vertical axis represents a capacitance (count value) of the sensor electrode 111 detected by the capacitance detection unit 122 by digitally converting an output of the measurement circuit 120A and integrating the output a predetermined number of times when the actual capacitance of the sensor electrode 111 corresponds to a value on the horizontal axis. The predetermined number is, for example, 128.

The vertical axis also indicates a short-circuit failure determination threshold THs used for determining a short-circuit failure of the sensor electrode 111 and an upper limit RU of a measurement range in the comparative electrostatic input device. The upper limit RU of the measurement range is determined by, for example, specifications of an IC chip used as the control device 120. A difference from a capacitance C2 described later is small, and a difference from the short-circuit failure determination threshold THs is even smaller. The upper limit RU of the measurement range is, for example, 4095, and the short-circuit failure determination threshold THs is, for example, 3800.

The comparative electrostatic input device cannot detect a capacitance greater than the upper limit RU of the measurement range. When the capacitance (count value) of the sensor electrode 111 detected by the capacitance detection unit 122 of the comparative electrostatic input device exceeds the upper limit RU of the measurement range, the capacitance (count value) output from the capacitance detection unit 122 is set to the value of the upper limit RU of the measurement range.

The capacitance Cp on the horizontal axis is the actual capacitance of the sensor electrode 111 when no touch operation is performed with the fingertip FT, and represents a parasitic capacitance of the sensor electrode 111. The capacitance Cf on the horizontal axis represents an actual capacitance between the fingertip FT and the sensor electrode 111. The actual capacitance of the sensor electrode 111 is Cp + Cf when a touch operation is performed with the fingertip FT.

In this case, as shown on the vertical axis of FIG. 3A, the capacitance detected by the capacitance detection unit 122 based on the capacitance Cp is C1, and the capacitance detected by the capacitance detection unit 122 based on the capacitance Cp + Cf is C2. The capacitance C1 is a capacitance detected by the capacitance detection unit 122 by integrating the capacitance Cp a predetermined number of times. The capacitance C2 is a capacitance detected by the capacitance detection unit 122 by integrating the capacitance Cp + Cf a predetermined number of times. In this case, the capacitance of the fingertip FT is a difference value ΔAD between C1 and C2.

Here, the short-circuit failure determination threshold THs is set to a value greater than the capacitance C2 detected by the capacitance detection unit 122 during a touch operation performed with the fingertip FT, and is set to a value such that the capacitance C2 does not exceed the short-circuit failure determination threshold THs as long as the touch operation is performed with the fingertip FT. Therefore, it is not determined that a short-circuit failure has occurred, and the determination unit 123 can perform operation determination based on the difference value ΔAD.

Next, with reference to FIG. 3B, capacitances detected by the capacitance detection unit 122 will be described in a case where none of the sensor electrodes 111 to 116 of the comparative electrostatic input device has a short-circuit failure and a palm, an arm, or another body part larger than the fingertip FT comes into contact with the operation surface 110B1. Here, as an example, a palm or part of an arm comes into contact with the region (1) corresponding to the sensor electrode 111. When a portion of the human body larger than the fingertip FT, such as a palm or part of an arm, comes into contact with the operation surface 110B1, the capacitance of the sensor electrode 111 becomes greater than that during a touch operation performed with the fingertip FT. The same applies to the sensor electrodes 112 to 116. Here, as an example, a palm comes into contact with the operation surface 110B1.

The horizontal and vertical axes in FIG. 3B are the same as those in FIG. 3A. The vertical axis also indicates the short-circuit failure determination threshold THs and the upper limit RU of the measurement range.

The capacitance Cp on the horizontal axis represents a parasitic capacitance of the sensor electrode 111, as in FIG. 3A. The capacitance Ch on the horizontal axis represents an actual capacitance between the palm and the sensor electrode 111. The actual capacitance of the sensor electrode 111 when the palm is in contact with the region (1) of the operation surface 110B1 is Cp + Ch.

In this case, as shown on the vertical axis of FIG. 3B, the capacitance detected by the capacitance detection unit 122 based on the capacitance Cp is C1, and the capacitance detected by the capacitance detection unit 122 based on the capacitance Cp + Ch is C3. The capacitance C3 is greater than the capacitance C2 shown in FIG. 3A, greater than the short-circuit failure determination threshold THs, and greater than the upper limit RU of the measurement range. The capacitance C3 is a capacitance detected by the capacitance detection unit 122 by integrating the capacitance Cp + Ch a predetermined number of times.

When the capacitance C3 exceeds the short-circuit failure determination threshold THs, the determination unit 123 may erroneously determine that a short-circuit failure has occurred in the sensor electrode 111 when a palm is in contact with the region (1) of the operation surface 110B1, and the control device 120 may transition from a normal mode to a safe mode. When the control device 120 transitions to the safe mode, the comparative electrostatic input device is unable to perform operation determination. The same applies when the palm comes into contact with any of regions (2) to (6) of the operation surface 110B1 corresponding to the sensor electrodes 112 to 116.

When a short-circuit failure actually occurs in the sensor electrode 111, a larger current than that when a palm is in contact with the operation surface 110B1 continues to flow through the sensor electrode 111, and the capacitance detected by the capacitance detection unit 122 becomes greater than the capacitance C3 and exceeds the short-circuit failure determination threshold THs. As a result, the determination unit 123 determines that a short-circuit failure has occurred in the sensor electrode 111. The same applies when a short-circuit failure occurs in any of the sensor electrodes 112 to 116.

Therefore, in the comparative electrostatic input device, it is not possible to distinguish whether a short-circuit failure has actually occurred in any of the sensor electrodes 111 to 116 or whether a palm, a part of an arm, or the like is in contact with any of the sensor electrodes 111 to 116 and has been erroneously determined as a short-circuit failure.

Such erroneous determination may also occur in the comparative electrostatic input device when electromagnetic compatibility (EMC) noise is generated and EMC noise is detected in any of the sensor electrodes 111 to 116.

### Operation Determination and Failure Determination in the Electrostatic Input Device 100 According to Embodiment

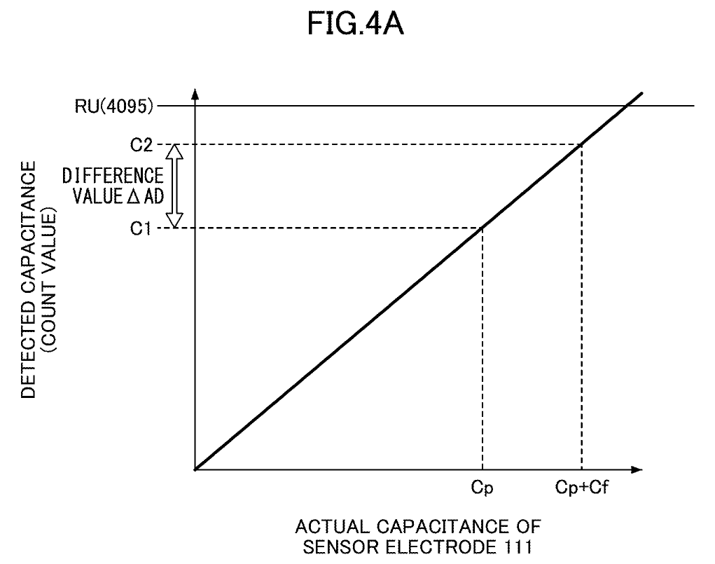

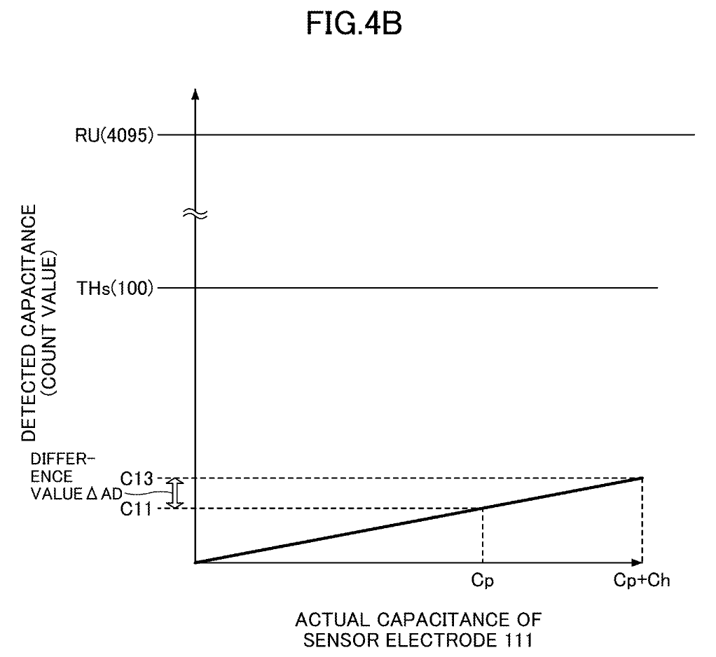

Here, operation determination and failure determination in the electrostatic input device 100 according to the embodiment will be described with reference to FIGS. 4A and 4B.

First, with reference to FIG. 4A, capacitances detected by the capacitance detection unit 122 during operation determination performed by the determination unit 123 will be described in a case where none of the sensor electrodes 111 to 116 of the electrostatic input device 100 according to the embodiment has a short-circuit failure. Here, as an example, a touch operation is performed on the region (1) corresponding to the sensor electrode 111.

In the electrostatic input device 100, for example, the sensor electrodes 111 to 116 are selected one by one, and failure determination is first performed. When no short-circuit failure has occurred, operation determination is then performed on the selected sensor electrode. Thus, when the electrostatic input device 100 performs operation determination with any one of the sensor electrodes 111 to 116 selected, no short-circuit failure has occurred in the selected sensor electrode (i.e., any one of the sensor electrodes 111 to 116).

The sensitivity setting unit 124 of the electrostatic input device 100 sets the output sensitivity of the measurement circuit 120A to a second output sensitivity in operation determination performed by the determination unit 123. The second output sensitivity is, for example, equal to the output sensitivity of the measurement circuit 120A of the comparative electrostatic input device and is greater than a first output sensitivity, which is the output sensitivity of the measurement circuit 120A in failure determination performed by the determination unit 123. When the output sensitivity of the measurement circuit 120A is set to the second output sensitivity, the gain of the amplifier of the measurement circuit 120A is set to a second gain (second amplification factor). The second gain is greater than a first gain (first amplification factor) set in the amplifier of the measurement circuit 120A in failure determination performed by the determination unit 123. The first gain is a gain set in the amplifier of the measurement circuit 120A when the output sensitivity of the measurement circuit 120A is the first output sensitivity. The sensitivity setting unit 124 sets the output sensitivity of the measurement circuit 120A to the first output sensitivity or the second output sensitivity.

The horizontal axis in FIG. 4A is the same as that in FIGS. 3A and 3B. Similar to the vertical axis in FIGS. 3A and 3B, the vertical axis in FIG. 4A indicates a capacitance (count value) detected by the capacitance detection unit 122. When the determination unit 123 performs operation determination, the capacitance detection unit 122 of the electrostatic input device 100 integrates an output of the measurement circuit 120A over a second number of integrations to detect capacitances of the sensor electrodes 111 to 116. The second number of integrations is, for example, equal to the number of integrations in the measurement circuit 120A of the comparative electrostatic input device and is greater than a first number of integrations, which is the number of integrations for failure determination performed by the determination unit 123. For example, the second number of integrations is 128, and the first number of integrations is four.

The vertical axis also indicates an upper limit RU of a measurement range in the electrostatic input device 100, but does not indicate a short-circuit failure determination threshold THs. The upper limit RU of the measurement range is, for example, the same as the upper limit RU of the measurement range illustrated in FIGS. 3A and 3B, and is determined by specifications of an IC chip used as the control device 120 or the like. For example, the upper limit RU of the measurement range is 4095. The short-circuit failure determination threshold THs will be described with reference to FIG. 4B.

The electrostatic input device 100 cannot detect a capacitance greater than the upper limit RU of the measurement range. When the capacitance (count value) of the sensor electrode 111 detected by the capacitance detection unit 122 of the electrostatic input device 100 exceeds the upper limit RU of the measurement range, the capacitance (count values) output by the capacitance detection unit 122 becomes the value of the upper limit RU of the measurement range. In this respect, the electrostatic input device 100 is similar to the comparative electrostatic input device.

The capacitance Cp on the horizontal axis is the actual capacitance of the sensor electrode 111 when no touch operation is performed with the fingertip FT, and represents a parasitic capacitance of the sensor electrode 111. The capacitance Cf on the horizontal axis represents an actual capacitance between the fingertip FT and the sensor electrode 111. The actual capacitance of the sensor electrode 111 is Cp + Cf when a touch operation is performed with the fingertip FT. This is the same as that in FIG. 3A.

In this case, as shown on the vertical axis of FIG. 4A, the capacitance detected by the capacitance detection unit 122 based on the capacitance Cp is C1, and the capacitance detected by the capacitance detection unit 122 based on the capacitance Cp + Cf is C2. The capacitance C1 is a capacitance detected by the capacitance detection unit 122 by integrating the capacitance Cp over the second number of integrations. The capacitance C2 is a capacitance detected by the capacitance detection unit 122 by integrating the capacitance Cp + Cf over the second number of integrations.

The output sensitivity of the measurement circuit 120A is set such that the capacitance C2 does not exceed the upper limit RU of the measurement range during a touch operation performed with the fingertip FT. Thus, in operation determination, the capacitance detection unit 122 of the electrostatic input device 100 can detect the capacitance C2 that is equal to or less than the upper limit RU of the measurement range and can output a difference value ΔAD between the capacitances C1 and C2 to the determination unit 123. As a result, the determination unit 123 can perform operation determination by comparing the difference value ΔAD with a touch operation threshold for determining a touch operation.

Next, with reference to FIG. 4B, capacitances detected by the capacitance detection unit 122 in failure determination performed by the determination unit 123 of the electrostatic input device 100 will be described in a case where none of the sensor electrodes 111 to 116 has a short-circuit failure and a palm, an arm, or another body part larger than the fingertip FT comes into contact with the operation surface 110B1. Here, as an example, similar to FIG. 3B, a palm comes into contact with the region (1) of the operation surface 110B1 corresponding to the sensor electrode 111

The horizontal axis in FIG. 4B is the same as that in FIG. 4A and represents an actual capacitance of the sensor electrode 111. Similar to the vertical axis in FIG. 4A, the vertical axis in FIG. 4B represents a capacitance (count value) detected by the capacitance detection unit 122 of the electrostatic input device 100, but has a different scale.

In failure determination performed by the determination unit 123 of the electrostatic input device 100, in order to distinguish an increase in capacitance caused by a palm touching the operation surface 110B1 from an increase in capacitance caused by a short-circuit failure in which a large current flows through the sensor electrode 111, and thereby suppress erroneous determination, the sensitivity setting unit 124 sets the output sensitivity of the measurement circuit 120A to a first output sensitivity, which is lower than the second output sensitivity. Accordingly, in the electrostatic input device 100, the gain of the amplifier of the measurement circuit 120A is set to the first gain, which is lower than the second gain, in failure determination performed by the determination unit 123.

Capacitance in a state where a large current flows through the sensor electrode 111 due to a short-circuit failure is significantly greater than capacitance in a state where a palm touches the operation surface 110B1. Thus, by significantly reducing the output sensitivity of the measurement circuit 120A in failure determination, these capacitances can be distinguished within a range equal to or less than the upper limit RU of the measurement range. Specifically, the value of the short-circuit failure determination threshold THs is set to a value greater than capacitance increased by a palm touching the operation surface 110B1 and less than capacitance increased by a short-circuit failure. For example, in FIG. 4B, the short-circuit failure determination threshold THs is 100 (count value), which is significantly smaller than the short-circuit failure determination threshold THs (3800) illustrated in FIGS. 3A and 3B.

That is, in failure determination performed by the determination unit 123, by setting the output sensitivity of the measurement circuit 120A to a very low first output sensitivity by the sensitivity setting unit 124 and setting the value of the short-circuit failure determination threshold THs as described above, it is possible to distinguish an increase in capacitance caused by a palm touching the operation surface 110B1 from an increase in capacitance caused by a short-circuit failure in which a large current flows through the sensor electrode 111 within a range equal to or less than the upper limit RU of the measurement range. Accordingly, it is possible to suppress erroneous determination in failure determination and improve determination accuracy of failure determination.

In FIG. 4B, the capacitance Cp on the horizontal axis represents a parasitic capacitance of the sensor electrode 111. The capacitance Ch on the horizontal axis represents an actual capacitance between the palm and the sensor electrode 111. The actual capacitance of the sensor electrode 111 when the palm is in contact with the region (1) of the operation surface 110B1 is Cp + Ch.

In this case, as shown on the vertical axis of FIG. 4B, the capacitance detected by the capacitance detection unit 122 based on the capacitance Cp is C11, and the capacitance detected by the capacitance detection unit 122 based on the capacitance Cp + Ch is C13. The capacitances C11 and C13 are smaller than capacitances C1 and C3 illustrated in FIG. 3B, respectively, because the output sensitivity of the measurement circuit 120A is set to the first output sensitivity (low value).

The capacitance C13 is reduced because the output sensitivity of the measurement circuit 120A is set to the first output sensitivity (low value), and is equal to or less than the short-circuit failure determination threshold THs (100) and equal to or less than the upper limit RU (4095) of the measurement range.

As described above, the first output sensitivity corresponds to a gain such that, even when coupling between the sensor electrode 111 and a palm becomes maximum due to an object touching the operation surface 110B1 in determination unit failure determination performed by the determination unit 123, capacitance of the sensor electrode 111 detected by the capacitance detection unit 122 is less than the short-circuit failure determination threshold THs (100).

When a short-circuit failure occurs in the sensor electrode 111, capacitance detected by the capacitance detection unit 122 only needs to exceed the short-circuit failure determination threshold THs (100), and may be a value equal to or less than the upper limit RU (4095) of the measurement range or a value greater than the upper limit RU (4095) of the measurement range. This is because, when the upper limit RU (4095) is exceeded, the output of the capacitance detection unit 122 becomes the upper limit RU (4095).

As described above, in the electrostatic input device 100, by setting the output sensitivity of the measurement circuit 120A to a first output sensitivity lower than the second output sensitivity by the sensitivity setting unit 124 in failure determination performed by the determination unit 123, it is possible to distinguish an increase in capacitance of the sensor electrode 111 caused by a palm touching the operation surface 110B1 from an increase in capacitance caused by a short-circuit failure of the sensor electrode 111. The same applies to the sensor electrodes 112 to 116.

Similarly, with respect to capacitance of the sensor electrode 111 increased by EMC noise, by setting the first output sensitivity such that the capacitance is equal to or less than the short-circuit failure determination threshold THs (100) and equal to or less than the upper limit RU (4095) of the measurement range, it is possible to distinguish the capacitance from that caused by a short-circuit failure of the sensor electrode 111, as in a case where the capacitance increases due to a palm touching the operation surface 110B1. The same applies to the sensor electrodes 112 to 116.

Accordingly, the electrostatic input device 100 can suppress erroneous determination in failure determination and improve determination accuracy of failure determination.

### Operation in Scan Period T

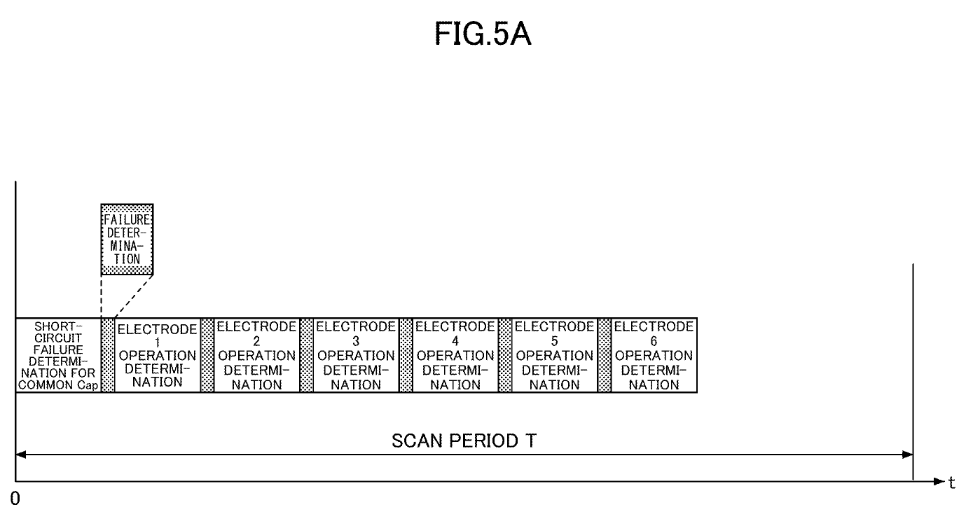

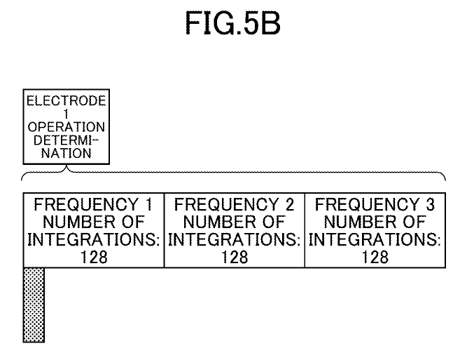

FIG. 5A is a diagram illustrating an example of operation of the electrostatic input device 100 in a scan period T. In FIG. 5A, the horizontal axis represents time t. FIG. 5A shows the scan period T in which the determination unit 123 of the electrostatic input device 100 performs failure determination and operation determination for the sensor electrodes 111 to 116. The scan period T is, for example, 10 milliseconds (ms). In FIG. 5A, the sensor electrodes 111 to 116 are indicated as electrodes 1 to 6.

Here, description will be given with reference to FIG. 5B in addition to FIG. 5A. FIG. 5B is a diagram illustrating an example of details of operation determination for the sensor electrode 111.

As illustrated in FIG. 5A, when one scan period T starts, the determination unit 123 first performs short-circuit failure determination on a common capacitor (common Cap) connected to the sensor electrodes 111 to 116, and then sequentially performs failure determination and operation determination on the sensor electrodes 111 to 116. Here, a processing procedure will be described in a case where no short-circuit failure has occurred in short-circuit failure determination for the common capacitor (common Cap) and in failure determination for the sensor electrodes 111 to 116.

When no short-circuit failure has occurred in both the short-circuit failure determination for the common capacitor (common Cap) and the failure determination for the sensor electrodes 111 to 116, a total time required for the short-circuit failure determination for the common capacitor (common Cap) and the failure determination and operation determination for the sensor electrodes 111 to 116 is shorter than the scan period T as illustrated in FIG. 5A.

After completing the short-circuit failure determination for the common capacitor (common Cap), the determination unit 123 selects the sensor electrode 111, performs failure determination for the sensor electrode 111, and then performs operation determination for the sensor electrode 111. After completing the failure determination and the operation determination for the sensor electrode 111, the determination unit 123 selects the sensor electrode 112, performs failure determination for the sensor electrode 112, and then performs operation determination for the sensor electrode 112. Thereafter, the sensor electrodes 113 to 116 are sequentially selected, and failure determination and operation determination are performed for the sensor electrodes 113 to 116.

Here, a time required for failure determination for each of the sensor electrodes 111 to 116 is shorter than a time required for operation determination.

In the electrostatic input device 100, the output sensitivity of the measurement circuit 120A is reduced to the first output sensitivity in failure determination. When the output sensitivity of the measurement circuit 120A is low, resistance to noise increases. Thus, the number of integrations performed by the capacitance detection unit 122 to detect capacitance can be reduced.

In the electrostatic input device 100, in order to increase resistance to noise during operation determination, capacitance is detected by sequentially applying AC power of a plurality of frequencies to each of the sensor electrodes 111 to 116. Since resistance to noise increases during failure determination, the number of frequencies (types) of AC power applied to each of the sensor electrodes 111 to 116 can be reduced.

By reducing the number of integrations during failure determination, a time required for failure determination can be shortened. Moreover, by reducing the number of frequencies (types) of AC power applied to each of the sensor electrodes 111 to 116, the time required for failure determination can be shortened.

The scan period T is a period set when failure determination for each of the sensor electrodes 111 to 116 is not performed. Since the time required for failure determination is short, failure determination for each of the sensor electrodes 111 to 116 can be executed without extending the scan period T. As illustrated in FIG. 5A, an end time of operation determination for the sensor electrode 116 is earlier than an end time of the scan period T, and the scan period T still has a time margin.

As illustrated in FIG. 5B, in operation determination for the sensor electrode 111, for example, AC power of three types of frequencies 1 to 3 is sequentially applied to the sensor electrode 111. FIG. 5B separately illustrates periods during which the AC power of the frequencies 1 to 3 is applied to perform operation determination. During application of the AC power of each frequency, the number of integrations (second number of integrations) performed by the capacitance detection unit 122 for operation determination is, for example, 128.

In contrast, in failure determination performed by the electrostatic input device 100, the number of frequencies (types) of AC power applied to each of the sensor electrodes 111 to 116 is, for example, one. Moreover, in failure determination performed by the electrostatic input device 100, the number of integrations (first number of integrations) performed by the capacitance detection unit 122 is, for example, four.

As described above, by reducing the number of integrations (second number of integrations) performed by the capacitance detection unit 122 during failure determination and reducing the number of frequencies (types) of AC power applied to each of the sensor electrodes 111 to 116, the time required for failure determination can be made shorter than the time required for operation determination.

Note that the number of frequencies (types) of AC power applied to each of the sensor electrodes 111 to 116 in operation determination performed by the electrostatic input device 100 is two or more. Moreover, the number of frequencies (types) of AC power applied to each of the sensor electrodes 111 to 116 in failure determination performed by the electrostatic input device 100 may be two or more if the number is less than the number of frequencies of AC power applied in operation determination.

In the above description, a processing procedure has been described in a case where no short-circuit failure has occurred. However, when a short-circuit failure of the common capacitor (common Cap) is detected in short-circuit failure determination for the common capacitor (common Cap), the electrostatic input device 100 transitions to a safe mode at that point. Moreover, when a short-circuit failure is detected in failure determination for any of the sensor electrodes 111 to 116, the electrostatic input device 100 transitions to the safe mode at that point.

### Flowchart

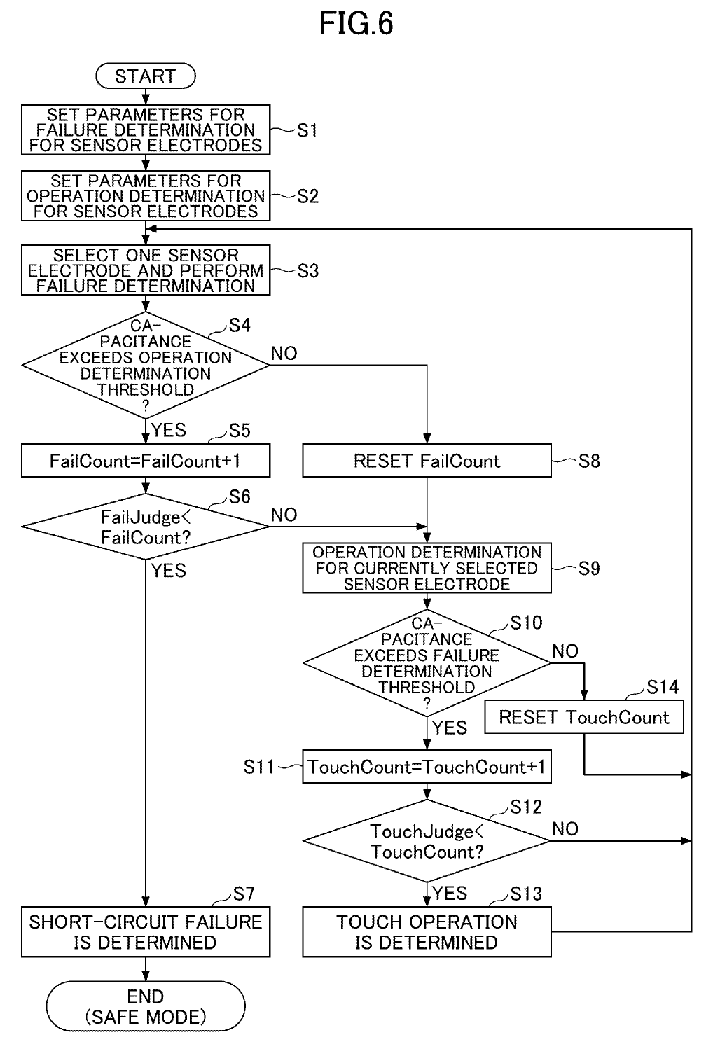

FIG. 6 is a flowchart illustrating an example of processes executed by the information processing unit 120B of the electrostatic input device 100.

The main control unit 121 sets parameters for failure determination for the sensor electrodes 111 to 116 (Step S1). The parameters for failure determination include the first output sensitivity, the first number of integrations, the number of frequencies (types) and frequency values of AC power applied to the sensor electrodes during detection of capacitance, and the like.

The main control unit 121 sets parameters for operation determination for the sensor electrodes 111 to 116 (Step S2). The parameters for operation determination include the second output sensitivity, the second number of integrations, the number of frequencies (types) and frequency values of AC power applied to the sensor electrodes during detection of capacitance, and the like.

The determination unit 123 selects one of the sensor electrodes 111 to 116 and performs failure determination (Step S3). After the main control unit 121 sets the number of frequencies of AC power applied to the sensor electrodes to a number for failure determination (e.g., one type), sets the output sensitivity of the measurement circuit 120A to the first output sensitivity, and sets the number of integrations performed by the capacitance detection unit 122 to the first number of integrations, the determination unit 123 selects one of the sensor electrodes 111 to 116 and performs failure determination by comparing capacitance detected by the capacitance detection unit 122 with the short-circuit failure determination threshold THs. By repeatedly performing the process of Step S3, the determination unit 123 sequentially selects the sensor electrodes 111 to 116 one by one.

The determination unit 123 determines whether capacitance of the selected sensor electrode detected by the capacitance detection unit 122 exceeds the short-circuit failure determination threshold THs (Step S4).

When the determination unit 123 determines in Step S4 that the capacitance exceeds the short-circuit failure determination threshold THs (S4: YES), the determination unit 123 increments a count value FailCount of a failure counter (Step S5). The determination unit 123 includes the failure counter that counts the count value FailCount. Incrementing the count value FailCount of the failure counter means calculating FailCount = FailCount + 1.

The determination unit 123 determines whether the count value FailCount of the failure counter exceeds a determination count threshold FailJudge for determining a failure (Step S6). The determination unit 123 determines whether FailJudge < FailCount is satisfied.

When the determination unit 123 determines in Step S6 that the count value FailCount of the failure counter exceeds the determination count threshold FailJudge (S6: YES), the determination unit 123 determines that a short-circuit failure has occurred in the sensor electrode selected in Step S3 (Step S7). As a result, the determination unit 123 notifies the ECU 50 that a short-circuit failure has occurred in the sensor electrode selected in Step S3. Accordingly, the electrostatic input device 100 transitions to a safe mode. After completing the process of Step S7 and transitioning to the safe mode, the electrostatic input device 100 stops operation (end). The state of the electrostatic input device 100 in the safe mode can be set to various states, such as a state in which operation of the electrostatic input device 100 is temporarily stopped (for a predetermined period of time), or a state in which operation is stopped until a recovery command is received from a higher-level device (e.g., the ECU 50).

When the determination count threshold FailJudge in Step S6 is, for example, 10, a process in which a NO determination is made in Step S6 and the flow returns to Step S3 and proceeds again to Step S6 is repeated 10 times, so that a YES determination is made in Step S6. For example, a YES determination may be made in Step S6 when the count value FailCount of the failure counter exceeds the determination count threshold FailJudge within 20 consecutive scan periods T illustrated in FIG. 5A. In this case, when the count value FailCount does not exceed the determination count threshold FailJudge within the 20 consecutive scan periods T illustrated in FIG. 5A, the count value FailCount may be reset. In this case, when the count value FailCount does not exceed the determination count threshold FailJudge within the 20 consecutive scan periods T illustrated in FIG. 5A, the count value FailCount may be reset. This is to determine whether a short-circuit failure has actually occurred within a period having a certain length, such as a period corresponding to 20 consecutive scan periods T.

When the determination unit 123 determines in Step S4 that the capacitance does not exceed the short-circuit failure determination threshold THs (S4: NO), the determination unit 123 resets the count value FailCount of the failure counter (Step S8). That is, FailCount = 0. After completing the process of Step S8, the determination unit 123 proceeds to Step S9.

When the determination unit 123 determines in Step S6 that the count value of the failure counter does not exceed the determination count threshold FailJudge (S6: NO), the determination unit 123 proceeds to Step S9.

In the process illustrated in FIG. 6, a period during which the processes of Steps S1 to S4 or Steps S1 to S6 are executed corresponds to a period during which failure determination is performed for the selected sensor electrode in FIG. 5A. The processes of Steps S8 to S14 correspond to a period during which operation determination is performed for the selected sensor electrode in FIG. 5A.

The determination unit 123 performs operation determination for a currently selected sensor electrode selected in Step S3 (Step S9). The currently selected sensor electrode is the sensor electrode selected in Step S3. After the main control unit 121 sets the number of frequencies of AC power applied to the sensor electrodes to a number for operation determination (e.g., three types), sets the output sensitivity of the measurement circuit 120A to the second output sensitivity, and sets the number of integrations performed by the capacitance detection unit 122 to the second number of integrations, the determination unit 123 performs operation determination by comparing a difference value ΔAD of capacitance output from the capacitance detection unit 122 for the sensor electrode selected in Step S3 with the operation determination threshold. By repeatedly performing the process from Step S3 to Step S9, the determination unit 123 sequentially selects the sensor electrodes 111 to 116 one by one and performs operation determination.

The determination unit 123 determines whether a difference value ΔAD of capacitance output from the capacitance detection unit 122 for the selected sensor electrode exceeds the operation determination threshold (Step S10).

When the determination unit 123 determines in Step S10 that the difference value ΔAD of capacitance exceeds the operation determination threshold (S10: YES), the determination unit 123 increments a count value TouchCount of a touch counter (Step S11). The determination unit 123 includes the touch counter that counts the count value TouchCount. Incrementing the count value TouchCount of the touch counter means calculating TouchCount = TouchCount + 1.

The determination unit 123 determines whether the count value TouchCount of the touch counter exceeds a determination count threshold TouchJudge for determining a touch operation (Step S12). The determination unit 123 determines whether TouchJudge < TouchCount is satisfied.

When the determination unit 123 determines in Step S12 that the count value TouchCount of the touch counter exceeds the determination count threshold TouchJudge (S12: YES), the determination unit 123 determines that a touch operation is performed on the sensor electrode selected in Step S3 (Step S13). As a result, the determination unit 123 notifies the ECU 50 that a touch operation is performed on the sensor electrode selected in Step S3.

When the determination unit 123 determines in Step S10 that the difference value ΔAD of capacitance does not exceed the operation determination threshold (S10: NO), the determination unit 123 resets the count value TouchCount of the touch counter (Step S14). That is, TouchCount = 0. After completing the process of Step S14, the determination unit 123 returns the flow to Step S3. As a result, in Step S3, a next one of the sensor electrodes 111 to 116 is selected, and a series of processes is continuously performed.

When the determination unit 123 determines in Step S12 that the count value TouchCount of the touch counter does not exceed the determination count threshold TouchJudge (S12: NO), or when the process of Step S13 is completed, the determination unit 123 returns the flow to Step S3. As a result, in Step S3, a next one of the sensor electrodes 111 to 116 is selected, and a series of processes is continuously performed. When the determination count threshold TouchJudge in Step S12 is, for example, 3, a process in which a NO determination is made in Step S12 and the flow returns to Step S3 and proceeds again to Step S12 is repeated 3 times, so that a YES determination is made in Step S12.

### ADVANTAGEOUS EFFECTS

The electrostatic input device 100 includes: a sensor electrode (any one of the sensor electrodes 111 to 116) provided on a back side of an operation surface 110B1 of a cover 110B; a measurement circuit 120A connected to the sensor electrode (any one of the sensor electrodes 111 to 116); a determination unit 123 configured to perform, based on a capacitance of the sensor electrode (any one of the sensor electrodes 111 to 116) obtained from an output of the measurement circuit 120A, a failure determination for determining a failure of the sensor electrode (any one of the sensor electrodes 111 to 116) and an operation determination for determining contact or proximity of an object to the operation surface 110B1; and a sensitivity setting unit 124 configured to set a first output sensitivity of the measurement circuit 120A in the failure determination performed by the determination unit 123 to be lower than a second output sensitivity of the measurement circuit 120A in the operation determination performed by the determination unit 123. With this configuration, by lowering the output sensitivity of the measurement circuit 120A in the failure determination, it is possible to distinguish an increase in capacitance of the sensor electrode 111 caused by contact of a large part of a human body (e.g., a palm) with the operation surface 110B1 from an increase in capacitance caused by a short-circuit failure of the sensor electrode 111.

Therefore, it is possible to provide the electrostatic input device 100 capable of improving determination accuracy of failure determination by lowering the output sensitivity of the capacitance when performing failure determination for a sensor electrode.

The electrostatic input device 100 may further include a capacitance detection unit 122 configured to detect the capacitance of the sensor electrode (any one of the sensor electrodes 111 to 116) based on the output of the measurement circuit 120A, in which the failure of the sensor electrode (any one of the sensor electrodes 111 to 116) is a short-circuit failure of the sensor electrode, the determination unit 123 is further configured to perform the failure determination by comparing the capacitance of the sensor electrode (any one of the sensor electrodes 111 to 116) detected by the capacitance detection unit 122 with a failure determination threshold, and the first output sensitivity is an amplification factor defined such that, even when coupling between the sensor electrode (any one of the sensor electrodes 111 to 116) and the object becomes maximum due to the contact or the proximity of the object to the operation surface 110B1 in the failure determination performed by the determination unit 123, the capacitance of the sensor electrode (any one of the sensor electrodes 111 to 116) detected by the capacitance detection unit 122 is lower than the failure determination threshold. With this configuration, it is possible to provide the electrostatic input device 100 capable of more reliably distinguishing between a state in which a large part of a human body (e.g., a palm) is in contact with the operation surface 110B1 and a state in which capacitance increases due to a short-circuit failure of the sensor electrode 111, and thus further improving determination accuracy of failure determination.

The electrostatic input device 100 may further include a capacitance detection unit 122 configured to detect the capacitance of the sensor electrode (any one of 111 to 116) by integrating the output of the measurement circuit 120A, in which the determination unit 123 is further configured to perform the failure determination and the operation determination using the capacitance of the sensor electrode (any one of 111 to 116) detected by the capacitance detection unit 122, and a first number of integrations for detecting the capacitance of the sensor electrode (any one of 111 to 116) in the failure determination performed by the determination unit 123 is smaller than a second number of integrations for detecting the capacitance of the sensor electrode (any one of 111 to 116) in the operation determination performed by the determination unit 123. By lowering the output sensitivity of the measurement circuit 120A in the failure determination, resistance to noise is increased. Thus, the number of integrations performed by the capacitance detection unit 122 to detect the capacitance can be reduced. Reducing the number of integrations enables failure determination to be performed in a shorter time, allowing failure determination to be realized without extending a scan period T of the electrostatic input device 100.

When the determination unit 123 performs operation determination, AC power having N (N is an integer of 2 or more) types of frequencies may be applied to the sensor electrode (any one of the sensor electrodes 111 to 116). When the determination unit 123 performs failure determination, AC power having M (M is a natural number less than N) types of frequencies may be applied to the sensor electrode (any one of the sensor electrodes 111 to 116). In operation determination, in order to reduce an influence of noise, a plurality of frequencies are used for AC power applied to the sensor electrode (any one of the sensor electrodes 111 to 116) when the capacitance detection unit 122 detects capacitance. This is because, when a frequency of noise is equal to a frequency of the AC power, the detected capacitance is affected by the noise. In contrast, in failure determination, resistance to noise is increased by lowering the output sensitivity of the measurement circuit 120A. Thus, even when the number of frequencies of the AC power applied to the sensor electrode (any one of the sensor electrodes 111 to 116) during detection of capacitance by the capacitance detection unit 122 is smaller than that in operation determination, the detected capacitance is less likely to be affected. Reducing the number of frequencies of the AC power enables failure determination to be performed in a shorter time, allowing failure determination to be realized without extending a scan period T of the electrostatic input device 100.

The determination unit 123 may perform failure determination for a sensor electrode (any one of the sensor electrodes 111 to 116), and may perform operation determination when it is determined that no failure has occurred in the sensor electrode (any one of the sensor electrodes 111 to 116). By performing failure determination before operation determination, operation determination can be performed in a state where no failure has occurred in the sensor electrode, improving determination accuracy of operation determination.

The electrostatic input device 100 may include a plurality of sensor electrodes 111 to 116, and the determination unit 123 may sequentially select the sensor electrodes 111 to 116 one by one from the plurality of sensor electrodes 111 to 116, and perform failure determination and operation determination for each of the sensor electrodes 111 to 116. With this configuration, it is possible to reliably determine whether a failure has occurred in each sensor electrode, improving reliability of the electrostatic input device 100.

The electrostatic detection device includes: a sensor electrode (any one of the sensor electrodes 111 to 116); a measurement circuit 120A connected to the sensor electrode (any one of the sensor electrodes 111 to 116); a determination unit 123 configured to perform, based on a capacitance of the sensor electrode (any one of the sensor electrodes 111 to 116) obtained from an output of the measurement circuit 120A, a failure determination for determining a failure of the sensor electrode (any one of the sensor electrodes 111 to 116) and a proximity determination for determining proximity of an object to the sensor electrode (any one of the sensor electrodes 111 to 116); and a sensitivity setting unit 124 configured to set a first output sensitivity of the measurement circuit 120A in the failure determination performed by the determination unit 123 to be lower than a second output sensitivity of the measurement circuit 120A in the proximity determination performed by the determination unit 123. With this configuration, by lowering the output sensitivity of the measurement circuit 120A in the failure determination, it is possible to distinguish an increase in capacitance of the sensor electrode 111 caused by contact of a large part of a human body (e.g., a palm) with the operation surface 110B1 from an increase in capacitance caused by a short-circuit failure of the sensor electrode 111.

Therefore, it is possible to provide the electrostatic detection device capable of improving determination accuracy of failure determination by lowering the output sensitivity of capacitance when performing failure determination for a sensor electrode.

The electrostatic detection device may further include a capacitance detection unit 122 configured to detect the capacitance of the sensor electrode (any one of the sensor electrodes 111 to 116) based on the output of the measurement circuit 120A, in which the failure of the sensor electrode (any one of the sensor electrodes 111 to 116) is a short-circuit failure of the sensor electrode, the determination unit 123 is further configured to perform the failure determination by comparing the capacitance of the sensor electrode (any one of the sensor electrodes 111 to 116) detected by the capacitance detection unit 122 with a failure determination threshold, and the first output sensitivity is an amplification factor defined such that, even when coupling between the sensor electrode (any one of the sensor electrodes 111 to 116) and the object becomes maximum due to the proximity of the object to the sensor electrode (any one of the sensor electrodes 111 to 116) in the failure determination performed by the determination unit 123, the capacitance of the sensor electrode (any one of the sensor electrodes 111 to 116) detected by the capacitance detection unit 122 is lower than the failure determination threshold. With this configuration, it is possible to provide the electrostatic detection device capable of more reliably distinguishing between a state in which a large part of a human body (e.g., a palm) is in contact with the operation surface 110B1 and a state in which capacitance increases due to a short-circuit failure of the sensor electrode 111, and thus further improving determination accuracy of failure determination.

The electrostatic detection device may further include a capacitance detection unit 122 configured to detect the capacitance of the sensor electrode (any one of 111 to 116) by integrating an output of the measurement circuit 120A, in which the determination unit 123 is further configured to perform the failure determination and the proximity determination using the capacitance of the sensor electrode (any one of 111 to 116) detected by the capacitance detection unit 122, and a first number of integrations for detecting the capacitance of the sensor electrode (any one of 111 to 116) in the failure determination performed by the determination unit 123 is smaller than a second number of integrations for detecting the capacitance of the sensor electrode (any one of 111 to 116) in the proximity determination performed by the determination unit 123. By lowering the output sensitivity of the measurement circuit 120A in the failure determination, resistance to noise is increased. Thus, the number of integrations performed by the capacitance detection unit 122 to detect the capacitance can be reduced. Reducing the number of integrations enables failure determination to be performed in a shorter time, allowing failure determination to be realized without extending a scan period T of the electrostatic detection device.

When the determination unit 123 performs proximity determination, AC power having N (N is an integer of 2 or more) types of frequencies may be applied to the sensor electrode (any one of the sensor electrodes 111 to 116). When the determination unit 123 performs failure determination, AC power having M (M is a natural number less than N) types of frequencies may be applied to the sensor electrode (any one of the sensor electrodes 111 to 116). In operation determination, in order to reduce an influence of noise, a plurality of frequencies are used for AC power applied to the sensor electrode (any one of the sensor electrodes 111 to 116) when the capacitance detection unit 122 detects capacitance. This is because, when a frequency of noise is equal to a frequency of the AC power, the detected capacitance is affected by the noise. In contrast, in failure determination, resistance to noise is increased by lowering the output sensitivity of the measurement circuit 120A. Thus, even when the number of frequencies of the AC power applied to the sensor electrode (any one of the sensor electrodes 111 to 116) during detection of capacitance by the capacitance detection unit 122 is smaller than that in operation determination, the detected capacitance is less likely to be affected. Reducing the number of frequencies of the AC power enables failure determination to be performed in a shorter time, allowing failure determination to be realized without extending a scan period T of the electrostatic detection device.

The determination unit 123 may perform failure determination for a sensor electrode (any one of the sensor electrodes 111 to 116), and may perform operation determination when it is determined that no failure has occurred in the sensor electrode (any one of the sensor electrodes 111 to 116). By performing failure determination before operation determination, operation determination can be performed in a state where no failure has occurred in the sensor electrode, improving determination accuracy of operation determination.

The electrostatic detection device may include a plurality of sensor electrodes 111 to 116, and the determination unit 123 may sequentially select the sensor electrodes 111 to 116 one by one from the plurality of sensor electrodes 111 to 116, and perform failure determination and proximity determination. With this configuration, it is possible to reliably determine whether a failure has occurred in each sensor electrode, improving reliability of the electrostatic input device 100.

Although the electrostatic input device and the electrostatic detection device according to exemplary embodiments of the present disclosure have been described, the present disclosure is not limited to the specifically disclosed embodiments, and various modifications and changes may be made without departing from the scope of the claims.

What is claimed is:

1. An electrostatic input device, comprising:
a sensor electrode provided on a back side of an operation surface of a cover;
a measurement circuit connected to the sensor electrode;
a memory; and
a processor coupled to the memory, wherein
the processor is configured to:
perform, based on a capacitance of the sensor electrode obtained from an output of the measurement circuit, a failure determination for determining a failure of the sensor electrode and an operation determination for determining contact or proximity of an object to the operation surface; and
set a first output sensitivity of the measurement circuit in the failure determination performed by the processor to be lower than a second output sensitivity of the measurement circuit in the operation determination performed by the processor.

2. The electrostatic input device according to claim 1, wherein
the failure of the sensor electrode is a short-circuit failure of the sensor electrode,
the processor is further configured to:
detect the capacitance of the sensor electrode based on the output of the measurement circuit; and
perform the failure determination by comparing the capacitance of the sensor electrode detected by the processor with a failure determination threshold, and
the first output sensitivity is an amplification factor defined such that, even when coupling between the sensor electrode and the object becomes maximum due to the contact or the proximity of the object to the operation surface in the failure determination performed by the processor, the capacitance of the sensor electrode detected by the processor is lower than the failure determination threshold.

3. The electrostatic input device according to claim 1, wherein
the processor is further configured to:
detect the capacitance of the sensor electrode by integrating the output of the measurement circuit; and
perform the failure determination and the operation determination using the capacitance of the sensor electrode detected by the processor, and
a first number of integrations for detecting the capacitance of the sensor electrode in the failure determination performed by the processor is smaller than a second number of integrations for detecting the capacitance of the sensor electrode in the operation determination performed by the processor.

4. The electrostatic input device according to claim 3, wherein
AC power having N (N is an integer of 2 or more) types of frequencies is applied to the sensor electrode in the operation determination performed by the processor, and AC power having M (M is a natural number less than N) types of frequencies is applied to the sensor electrode in the failure determination performed by the processor.

5. The electrostatic input device according to claim 1, wherein
the processor is further configured to perform the failure determination for the sensor electrode , and perform the operation determination when it is determined that no failure has occurred in the sensor electrode.

6. The electrostatic input device according to claim 1, further comprising
a plurality of the sensor electrodes, wherein
the processor is further configured to sequentially select the plurality of sensor electrodes one by one and perform the failure determination and the operation determination for each of the sensor electrodes.

7. An electrostatic detection device, comprising:
a sensor electrode;
a measurement circuit connected to the sensor electrode;
a memory; and
a processor coupled to the memory, wherein
the processor is configured to:
perform, based on a capacitance of the sensor electrode obtained from an output of the measurement circuit, a failure determination for determining a failure of the sensor electrode and a proximity determination for determining proximity of an object to the sensor electrode; and
set a first output sensitivity of the measurement circuit in the failure determination performed by the processor to be lower than a second output sensitivity of the measurement circuit in the proximity determination performed by the processor.

8. The electrostatic detection device according to claim 7, wherein
the failure of the sensor electrode is a short-circuit failure of the sensor electrode,
the processor is further configured to:
detect the capacitance of the sensor electrode based on the output of the measurement circuit; and
perform the failure determination by comparing the capacitance of the sensor electrode detected by the processor with a failure determination threshold, and
the first output sensitivity is an amplification factor defined such that, even when coupling between the sensor electrode and the object becomes maximum due to the proximity of the object to the sensor electrode in the failure determination performed by the processor, the capacitance of the sensor electrode detected by the processor is lower than the failure determination threshold.

9. The electrostatic detection device according to claim 7, wherein
the processor is further configured to:
detect the capacitance of the sensor electrode by integrating the output of the measurement circuit; and
perform the failure determination and the proximity determination using the capacitance of the sensor electrode detected by the processor, and
a first number of integrations for detecting the capacitance of the sensor electrode in the failure determination performed by the processor is smaller than a second number of integrations for detecting the capacitance of the sensor electrode in the proximity determination performed by the processor.

10. The electrostatic detection device according to claim 9, wherein
AC power having N (N is an integer of 2 or more) types of frequencies is applied to the sensor electrode in the proximity determination performed by the processor, and AC power having M (M is a natural number less than N) types of frequencies is applied to the sensor electrode in the failure determination performed by the processor.

11. The electrostatic detection device according to claim 7, wherein
the processor is further configured to perform the failure determination for the sensor electrode, and perform the proximity determination when it is determined that no failure has occurred in the sensor electrode.

12. The electrostatic detection device according to claim 7, further comprising:
a plurality of the sensor electrodes, wherein
the processor is further configured to sequentially select the plurality of sensor electrodes one by one and perform the failure determination and the proximity determination for each of the sensor electrodes.
